(19) United States
(12) Patent Application Publication
(10) Pub. No.: US 2023/0315177 A1
(43) Pub. Date: Oct. 5, 2023

(54) POWER SUPPLIED TO PORTS BASED ON CHARGE AMOUNTS

(71) Applicant: Hewlett-Packard Development Company, L.P., Spring, TX (US)

(72) Inventors: YI-FAN HSIA, TAIPEI CITY (TW); SHAO-YU CHIANG, TAIPEI CITY (TW); HUNG LUNG CHEN, TAIPEI CITY (TW)

(73) Assignee: Hewlett-Packard Development Company, L.P., Spring, TX (US)

(21) Appl. No.: 18/040,620

(22) PCT Filed: Sep. 1, 2020
(86) PCT No.: PCT/US2020/048907

§ 371 Date: Feb. 3, 2023

(51) Int. Cl. G06F 1/26; G06F 1/28; H02J 7/00

(52) U.S. Cl. CPC G06F 1/266; G06F 1/28; H02J 7/00714

(57) ABSTRACT

Example implementations relate to power supplied to ports based on charge amounts. In some examples, a computing device can include a charge storage device, an I/O port, and a processor, where the processor is to determine a charge amount of the charge storage device and an operating mode of the computing device, and determine an amount of power to be supplied to the I/O port based on the charge amount and the operating mode.

### BACKGROUND

Some users of computing devices may utilize their computing devices in different environments. Certain computing devices can be portable to allow a user to carry or otherwise bring with the computing device while in a mobile setting. A computing device can allow a user to utilize computing device operations for work, education, gaming, multimedia, and/or other general use in a mobile setting.

### BRIEF DESCRIPTION OF THE DRAWINGS

FIG. 1 illustrates an example of a power mains and a computing device including an input/output (I/O) port and a charge storage device consistent with the disclosure.

FIG. 2 illustrates an example of a computing device including an input/output (I/O) port and a charge storage device consistent with the disclosure.

FIG. 3 illustrates an example of a computing device including a Universal Serial Bus Type-C (USB-C) port and a charge storage device consistent with the disclosure.

FIG. 4 illustrates a block diagram of an example system for power supplied to ports based on charge amounts consistent with the disclosure.

### DETAILED DESCRIPTION

A user may utilize a computing device for various purposes, such as for business and/or recreational use. As used herein, the term “computing device” refers to an electronic system having a processing resource, memory resource, and/or an application-specific integrated circuit (ASIC) that can process information. A computing device can be, for example, a laptop computer, a notebook, a tablet, and/or a mobile device, among other types of computing devices.

Some computing devices may include I/O ports. As used herein, the term “I/O port” refers to an interface between a computing device and other computing devices and/or peripheral devices, An I/O port included on a computing device can be used to connect the computing device with other computing devices and/or peripheral devices in order to receive and/or transmit information to and/or from the other computing devices and/or peripheral devices. For example, an I/O port may be utilized to connect a peripheral device to a computing device which can receive information from the computing device and/or transmit information to the computing device.

In some examples, certain I/O ports may have to be powered by the computing device. Providing power to an I/O port can facilitate operation of the I/O port and/or operation of a device (e.g., a peripheral device) connected to the I/O port.

Power can be provided to an I/O port by the computing device. For example, a charge storage device included in the computing device can provide power to the I/O port. As used herein, the term “charge storage device” refers to a device to store an electric charge. The charge storage device can be, for instance, a battery, a capacitor, and/or other types of charge storage devices. Such a charge storage device can provide power to an I/O port when a computing device is being utilized in a mobile setting.

Such power provided to an I/O port can affect a charge amount of the charge storage device. As used herein, the term “charge amount” refers to an amount of electric charge stored in a charge storage device. For example, when power is provided to the I/O port by the charge storage device, the charge amount in the charge storage device can be depleted.

In some instances, it may not be clear to a user of the computing device the amount of power being provided to the I/O port by the charge storage device. As a result, it may not be clear to a user as to why the charge storage device is being depleted so quickly (e.g., relative to when the I/O port is not receiving power from the charge storage device). This can lead to a negative user experience for a user of the computing device.

As described below, the computing device can determine an amount of power to be supplied to the I/O port based on a charge amount of the charge storage device and an operating mode of the computing device. Such power determination can prolong the charge amount of the charge storage device of the computing device, which can lead to a more positive user experience for a user as compared with previous approaches.

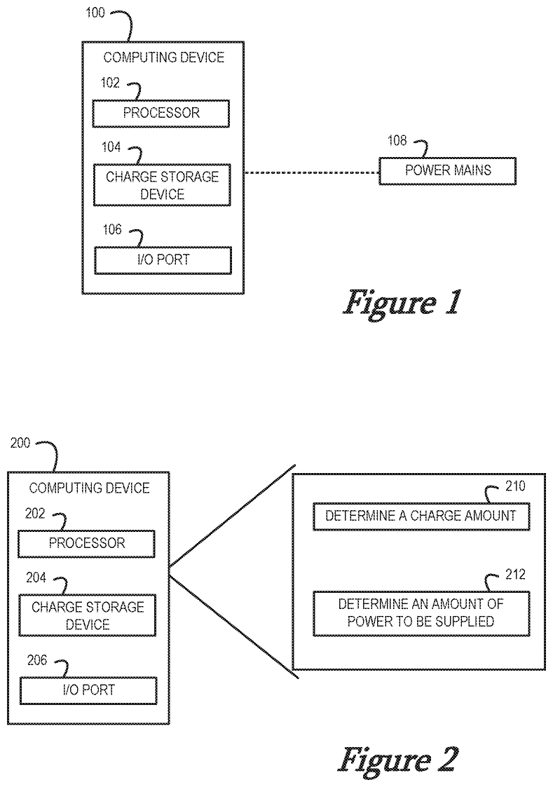

FIG. 1 illustrates an example of a power mains 108 and a computing device 100 including an I/O port 106 and a charge storage device 104 consistent with the disclosure. As illustrated in FIG. 1, the computing device 100 can include a processor 102, a charge storage device 104, and an I/O port 106.

The computing device 100 can include a charge storage device 104. As described above, the charge storage device 104 can provide power to components of the computing device 100. For example, when the computing device 100 is in a mobile setting, the computing device 100 may not be connected to a power mains 108. As used herein, the term “power mains” refers to a supply of alternating-current (AC) power. Accordingly, the computing device 100 can be powered by the charge storage device 104, which can provide a supply of direct-current (DC) power to the computing device 100 and/or its components.

The computing device 100 can include an I/O port 106. As described above, the I/O port 106 can allow the computing device 100 to be connected to other computing devices and/or peripheral devices to allow communication (e.g., receipt and/or transmission of information) between the computing device 100 and the other computing device(s) and/or peripheral device(s). In some examples, the I/O port 106 can be powered by the charge storage device 104, as is further described herein.

The processor 102 can determine a power supply mode of the computing device 100. As used herein, the term “power supply mode” refers to a status based on a type of power being supplied to the computing device 100. For example, the computing device 100 can be powered by the charge storage device 104 or by the power mains 108. When the computing device 100 is powered by the charge storage device 104, the power supply mode of the computing device 100 can be a DC power supply mode, and when the computing device 100 is powered by the power mains 108, the power supply mode of the computing device 100 can be an AC power supply mode, as is further described herein.

The processor 102 can determine the power supply mode of the computing device 100 is a DC power supply mode in response to the charge storage device 104 providing power to the computing device 100. As used herein, the term “DC power supply mode” refers to a status of a computing device in which DC power is supplied to the computing device by a charge storage device. For example, the processor 102 can determine that the computing device 100 is in a DC power supply mode in response to the charge storage device 104 providing power to the computing device 100.

The processor 102 can determine a charge amount of the charge storage device 104 and an operating mode of the computing device 100. For example, the processor 102 can determine the charge amount of the charge storage device 104 to be 83%, 52%, 21%, or any other amount of electric charge stored in the charge storage device 104.

As used herein, the term “operating mode” refers to an operational status of a computing device that is based on a performance relative to a amount of time the charge storage device includes a charge amount. For example, the operating mode can include a performance mode or a charge storage device saver mode, as is further described herein.

In some examples, the operating mode can be a performance mode. As used herein, the term “performance mode” refers to an operating mode in which an amount of performance is requested at the expense of an amount of time the charge storage device includes a charge amount. For example, the performance mode may allow for additional processing operations (e.g., relative to the charge storage device saver mode) at the expense of the amount of time the charge storage device 104 includes a charge amount, as the additional processing operations may incur additional power, generate more heat, etc. relative to a charge storage device saver mode. In other words, the performance mode can allow for higher computing performance (e.g., more processing) but cause a charge amount of the charge storage device 104 to deplete faster relative to a charge storage device saver mode.

In some examples, the operating mode can be a charge storage device saver mode. As used herein, the term “charge storage device saver mode” refers to an operating mode in which an amount of time the charge storage device includes a requested charge amount at the expense of performance. For example, the charge storage device saver mode may allow for less processing operations (e.g., relative to the performance mode) in order to gain an amount of time the charge storage device 104 includes a charge amount (e.g., relative to the performance mode), as less processing operations may incur less power relative to a performance mode. In other words, the charge storage device saver mode can allow for lower computing performance (e.g., less processing) but cause a charge amount of the charge storage device 104 to deplete slower relative to a performance mode. The charge storage device saver mode can allow for longer operating times for the computing device 100.

The processor 102 can determine the charge amount of the charge storage device 104 and determine the operating mode based on the power supply mode being the DC power supply mode. For example, the processor 102 can determine the charge amount of the charge storage device 104 to be 83%, 52%, 21%, etc., and determine the operating mode of the computing device 100 to be a charge storage device saver mode.

The processor 102 can determine an amount of power to be supplied to the I/O port 106 based on the charge amount and the operating mode. For example, in response to the power supply mode being the DC power supply mode, the operating mode being the charge storage device saver mode, and the charge amount of the charge storage device 104, the processor 102 can determine a first amount of power to be supplied to the I/O port 106 or a second amount of power to be supplied to the I/O port 106, where the second amount of power is less than the first amount of power, as is further described herein.

For instance, the processor 102 can determine the power supply mode of the computing device to be the DC power supply mode, the operating mode being the charge storage device saver mode, and the charge amount of the charge storage device 104 to be 83%. The processor 102 can determine the first charge amount (e.g., 83%) to be in a first charge amount range, where the first charge amount range can be a range between 100% and 70%. In response to the charge amount (e.g., 83%) being in the first charge amount range, the processor 102 can cause a first amount of power to be supplied to the I/O port 106. For example, when the computing device 100 is in the DC power supply mode, the operating mode is the charge storage device saver mode, and the charge amount of the charge storage device 104 is within a first charge amount range, the processor 102 can cause a first amount of power to be supplied to the I/O port 106. The first amount of power can be, for example, 5 Volts (V)/3 Amperes (A) (e.g., 36 Watts (W)), among other examples.

In some examples, the processor 102 can determine the charge amount of the charge storage device 104 to be a second charge amount. For instance, the processor 102 can determine the power supply mode of the computing device to be the DC power supply mode, the operating mode being the charge storage device saver mode, and the charge amount of the charge storage device 104 to be 52%, The processor 102 can determine the second charge amount (e.g., 52%) to be in a second charge amount range, where the second charge amount range can be a range between 69% and 40%. In response to the charge amount (e.g., 52%) being in the second charge amount range, the processor 102 can cause a second amount of power to be supplied to the I/O port 106. For example, when the computing device 100 is in the DC power supply mode, the operating mode is the charge storage device saver mode, and the charge amount of the charge storage device 104 is within a second charge amount range, the processor 102 can cause a second amount of power to be supplied to the I/O port 106. The second amount of power can be, for example, 5V/1A (e.g., 16 W), among other examples. In other words, when the charge amount in the charge storage device 104 exceeds a first threshold amount, the amount of power supplied to the I/O port 106 can be lowered to the second amount of power, which can extend an amount of time an amount of charge remains within the charge storage device 104 relative to the first amount of power.

In some examples, the processor 102 can determine the charge amount of the charge storage device 104 to be a third charge amount. For instance, the processor 102 can determine the power supply mode of the computing device to be the DC power supply mode, the operating mode being the charge storage device saver mode, and the charge amount of the charge storage device 104 to be 21%. The processor 102 can determine the third charge amount (e.g., 21%) to be in a third charge amount range, where the third charge amount range can be a range between 39% and 0%. In response to the charge amount (e.g., 21%) being in the third charge amount range, the processor 102 can cause power to the I/O port 106 to be disabled. For example, when the computing device 100 is in the DC power supply mode, the operating mode is the charge storage device saver mode, and the charge amount of the charge storage device 104 is within a third charge amount range, the processor 102 can cause power to the I/O port 106 to be disabled. In other words, when the charge amount in the charge storage device 104 exceeds a second threshold amount, the power supplied to the I/O port 106 can be disabled (e.g., 0 W), which can extend an amount of time an amount of charge remains within the charge storage device 104 relative to the first amount of power and/or the second amount of power.

Although the first charge amount range is described above as being 100% to 70%, the second charge amount range is described above as being 69% to 40%, and the third charge amount range is described above as being 39% to 0%, examples of the disclosure are not so limited. For example, the first, second, and third charge amount ranges can be any other ranges.

In some examples, the processor 102 can determine the charge amount of the charge storage device 104 and determine the operating mode based on the power supply mode being the DC power supply mode. For example, the processor 102 can determine the charge amount of the charge storage device 104 to be 83%, 52%, 21%, etc., and determine the operating mode of the computing device 100 to be a performance mode.

For instance, the processor 102 can determine the power supply mode of the computing device to be the DC power supply mode, the operating mode being the performance mode, and the charge amount of the charge storage device 104 to be 83%. The processor 102 can cause a first amount of power to be supplied to the I/O port 106. For example, when the computing device 100 is in the DC power supply mode and the operating mode is the performance mode, the processor 102 can cause a first amount of power to be supplied to the I/O port 106. The first amount of power can be, for example, 5V/3A (e.g., 36 W), among other examples. When the power supply mode is the DC power supply mode and the operating mode is the performance mode, the processor 102 can cause the first amount of power to be supplied to the I/O port 106 no matter the charge amount of the charge storage device 104. For example, the charge amount of the charge storage device 104 can be determined to be 83%, 52%, 21%, or any other charge amount, and because the operating mode is the performance mode, the processor can still cause the first amount of power to be supplied to the I/O port 106.

In some examples, the computing device 100 can be connected to the power mains 108. When the computing device 100 is connected to the power mains 108, the computing device 100 can receive power from the power mains 108. In such an example, the processor 102 can determine the power supply mode of the computing device 100 is an AC power supply mode in response to the power mains 108 providing power to the computing device 100. As used herein, the term “AC power supply mode” refers to a status of a computing device in which AC power is supplied to the computing device by a power mains. In response to the power supply mode of the computing device 100 being the AC power supply mode, the processor 102 can cause a first amount of power to be supplied to the I/O port 106. In some examples, the first amount of power can be a full amount of power. As used herein, the term “full amount of power” refers to a maximum amount of power based on design specifications for a device. For example, the processor 102 can cause 5V/3A (e.g., 16 W) to be provided to the I/O port 106 when the power supply mode of the computing device 100 is an AC power supply mode. Providing a full amount of power to the I/O port 106 can be accomplished when the power supply mode of the computing device 100 is an AC power supply mode as charge storage time considerations are less of a priority as the charge storage device 104 is not providing power to the computing device 100 and/or I/O port 106.

FIG. 2 illustrates an example of a computing device 200 including an I/O port 206 and a charge storage device 204 consistent with the disclosure. As illustrated in FIG. 2, the computing device 200 can include a processor 202, charge storage device 204, and an I/O port 206.

The processor 202 can, at 210, determine a charge amount of the charge storage device 204 and an operating mode of the computing device 200. For example, the processor 202 can determine the charge amount of the charge storage device 204 to be 83%, 52%, 21%, or any other charge amount. Further, the processor 202 can determine the operating mode of the computing device to be a performance mode or a charge storage device saver mode.

The processor 202 can, at 212, determine an amount of power to be supplied to the I/O port 206 based on the charge amount and the operating mode. For example, in response to a power supply mode of the computing device 200 being a DC power supply mode, the operating mode of the computing device 200 being a charge storage device saver mode, and the charge amount of the charge storage device 204 to be within a first charge amount range, the processor 202 can cause a first amount of power to be supplied to the I/O port 206. Additionally, in response to a power supply mode of the computing device 200 being a DC power supply mode, the operating mode of the computing device 200 being a charge storage device saver mode, and the charge amount of the charge storage device 204 to be within a second charge amount range, the processor 202 can cause a second amount of power to be supplied to the I/O port 206, where the second amount of power is less than the first amount of power. Further, in response to a power supply mode of the computing device 200 being a DC power supply mode, the operating mode of the computing device 200 being a charge storage device saver mode, and the charge amount of the charge storage device 204 being within a third charge amount range, the processor 202 can cause power to the I/O port 206 to be disabled.

FIG. 3 illustrates an example of a computing device 300 including a Universal Serial Bus Type-C (USB-C) port 314 and a charge storage device 304 consistent with the disclosure. As illustrated in FIG. 3, the computing device 300 can include a processor 302, a charge storage device 304, and a USB-C port 314.

The processor 302 can, at 316, cause a first amount of power to be supplied to the USB-C port 314. For example, the computing device 300 may be powered by the charge storage device 304 or a power mains (e.g., not illustrated in FIG. 3). A first amount of power (e.g., 5V/3A, or 36 W) may be provided to the USB-C port 314 to provide power to the USB-C port 314 and/or a device (e.g., another computing device, a peripheral device, etc.) that may be connected to the USB-C port 314.

The processor 302 can, at 318, determine a power supply mode of the computing device 300. For example, the processor 302 can determine the power supply mode of the computing device to be a DC power supply mode in response to the charge storage device 304 providing power to the computing device 300.

In response to the power supply mode being a DC power supply mode, the processor 302 can, at 320, determine a charge amount of the charge storage device 304 and an operating mode of the computing device 300. For example, the processor 302 can determine the charge amount of the charge storage device 304 to be 83% and the operating mode of the computing device 300 to be a charge storage device saver mode.

The processor 302 can, at 322, determine when the charge amount of the charge storage device 304 is below a threshold amount in response to the operating mode being the charge storage device saver mode. For example, as the computing device 300 is in operation, a charge amount of the charge storage device 304 can be depleted. The processor 302 can, for instance, determine the charge amount to be 52%. The processor 302 can determine the charge amount (e.g., 52%) to be below a threshold amount (e.g., 70%). In some examples, the threshold amount can be defined by a lower bound of a charge amount range (e.g., 100% to 70%), among other examples.

In response to the charge amount being below the threshold amount, the processor 302 can, at 324, alter an amount of power to be supplied to the USB-C port 314. For example, the processor 302 can alter an amount of power supplied to the USB-C port 314 from a first amount of power (e.g., 5V/3A, 36 W) to a second amount of power (e.g., 5V/1A, 16 W) in response to the charge amount of the charge storage device 304 being below the threshold amount.

In some examples, a user may connect the computing device 300 to a power mains. In such an example, the processor 302 can determine the computing device is connected to the power mains. In response to the computing device 300 being connected to the power mains, the processor 302 can modify the power supply mode from the DC power supply mode to an AC power supply mode. Additionally, in response to the power supply mode being the AC power supply mode, the processor 302 can modify the operating mode from a charge storage device mode to a performance mode.

The processor 302 can determine an amount of power to be supplied to the USB-C port 314 based on the operating mode of the computing device being the performance mode. For example, the processor 302 can determine the amount of power to be supplied to the USB-C port 314 to be 5V/3A, 36 W and cause the third amount of power to be supplied to the USB-C port.

In some examples, the computing device 300 can be powered by the charge storage device 304 such that the power supply mode of the computing device 300 is a DC power supply mode and the operating mode is a charge storage device saver mode. A user can, in some instances, modify the operating mode from the charge storage device saver mode to a performance mode in response to a user input. For example, a user may utilize an operating mode slider via a user interface provided by a display of a display device (e.g., not illustrated in FIG. 3). The user can slide a pointer from the charge storage device saver mode to a performance mode utilizing the operating mode slider. Such an interaction through the user interface can cause the operating mode of the computing device 300 to be modified from the charge storage device saver mode to the performance mode.

In response to the user input described above, the processor 302 can determine an amount of power to be supplied to the USB-C port 314 based on the operating mode being the performance mode. For example, the processor 302 can determine an amount of power to be supplied to the USB-C port 314 to be 5V/3A, 36 W and cause the amount of power to be supplied to the USB-C port 314.

Power supplied to ports based on charge amounts according to the disclosure can allow for determination of an amount of power to be provided to an I/O port of a computing device based on the amount of charge included in a charge storage device of the computing device and an operating mode of the computing device. By providing different amounts of power to an I/O port based on a charge amount of the charge storage device when the charge storage device is powering the computing device, the charge amount in the charge storage device can be prolonged, which can lead to a more positive user experience as compared with previous approaches.

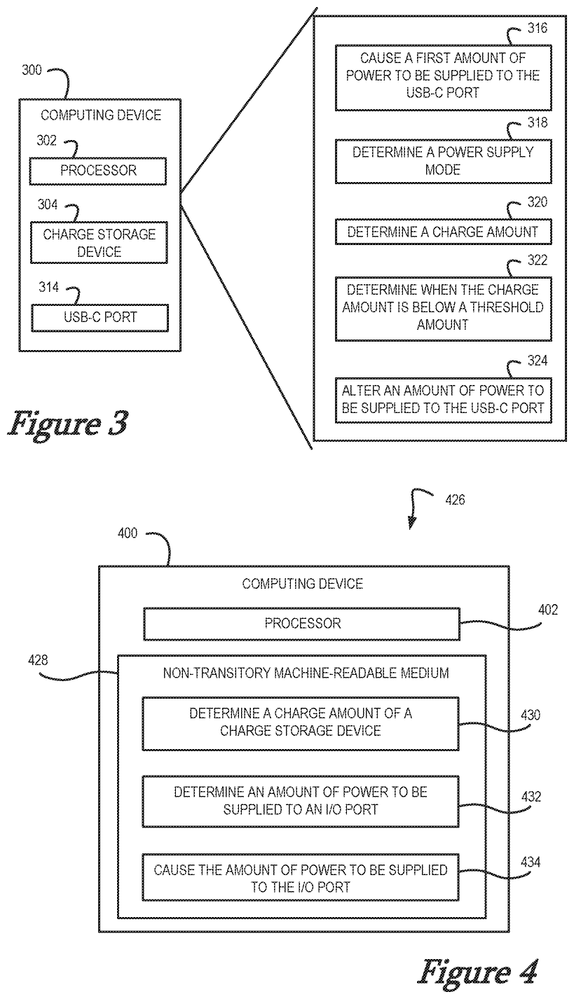

FIG. 4 illustrates a block diagram of an example system 426 for power supplied to ports based on charge amounts consistent with the disclosure. In the example of FIG. 4, system 426 includes a processor 402 and a non-transitory machine-readable storage medium 428. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 402 may be a central processing unit (CPU), microprocessor, and/or other hardware device suitable for retrieval and execution of instructions stored in machine-readable storage medium 428. In the particular example shown in FIG. 4, processor 402 may receive, determine, and send instructions 430, 432, 434. As an alternative or in addition to retrieving and executing instructions, processor 402 may include an electronic circuit comprising a number of electronic components for performing the operations of the instructions in machine-readable storage medium 428. With respect to the executable instruction representations or boxes described and shown herein, it should be understood that part or all of the executable instructions and/or electronic circuits included within one box may be included in a different box shown in the figures or in a different box not shown.

Machine-readable storage medium 428 may be any electronic, magnetic, optical, or other physical storage device that stores executable instructions. Thus, non-transitory machine-readable storage medium 428 may be, for example, Random Access Memory (RAM), an Electrically-Erasable Programmable Read-Only Memory (EEPROM), a storage drive, an optical disc, and the like. The executable instructions may be “installed” on the system 426 illustrated in FIG. 4. Machine-readable storage medium 428 may be a portable, external or remote storage medium, for example, that allows the system 426 to download the instructions from the portable/external/remote storage medium. In this situation, the executable instructions may be part of an “installation package”.

Determine instructions 430, when executed by a processor such as processor 402, may cause system 426 to determine a charge amount of a charge storage device of the computing device 400 and an operating mode of the computing device 400, where the charge storage device is to provide power to the computing device 400. The operating mode of the computing device 400 can be a performance mode or a charge storage device saver mode.

Determine instructions 432, when executed by a processor such as processor 402, may cause system 426 to determine an amount of power to be supplied to an I/O port based on the charge amount and the operating mode being the charge storage device saver mode. Further, the system 426 can determine the amount of power to be supplied to the I/O port based on the computing device 400 being a DC power supply mode. The I/O port can be, for example, a USB-C port.

Cause instructions 434, when executed by a processor such as processor 402, may cause system 426 to cause the amount of power to be supplied to the I/O port. For example, in response to a power supply mode of the computing device 400 being a DC power supply mode, the operating mode of the computing device 400 being a charge storage device saver mode, and the charge amount of the charge storage device 404 to be within a first charge amount range, the processor 402 can cause a first amount of power to be supplied to the I/O port. Additionally, in response to a power supply mode of the computing device 400 being a DC power supply mode, the operating mode of the computing device 400 being a charge storage device saver mode, and the charge amount of the charge storage device 404 to be within a second charge amount range, the processor 402 can cause a second amount of power to be supplied to the I/O port, where the second amount of power is less than the first amount of power. Further, in response to a power supply mode of the computing device 400 being a DC power supply mode, the operating mode of the computing device 400 being a charge storage device saver mode, and the charge amount of the charge storage device being within a third charge amount range, the processor 402 can cause power to the I/O port to be disabled.

In the foregoing detailed description of the disclosure, reference is made to the accompanying drawings that form a part hereof, and in which is shown by way of illustration how examples of the disclosure may be practiced. These examples are described in detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, “a plurality of” an element and/or feature can refer to more than one of such elements and/or features.

What is claimed:

1. A computing device, comprising:
a charge storage device;
an input/output (I/O) port; and
a processor, wherein the processor is to:
determine a charge amount of the charge storage device and an operating mode of the computing device; and
determine an amount of power to be supplied to the I/O port based on the charge amount and the operating mode.

2. The computing device of claim 1, wherein the processor is to determine a power supply mode of the computing device.

3. The computing device of claim 2, wherein the processor is to determine the power supply mode is a direct current (DC) power supply mode in response to the charge storage device providing power to the computing device.

4. The computing device of claim 3, wherein processor is to determine the charge amount and the operating mode based on the power supply mode being the DC power supply mode.

5. The computing device of claim 4, wherein in response to the power supply mode being the DC power supply mode, the processor is to cause:
a first amount of power to be supplied to the I/O port; or
a second amount of power to be supplied to the I/O port;
wherein the second amount of power is less than the first amount of power.

6. The computing device of claim 2, wherein the processor is to determine
the power supply mode is an alternating current (AC) power supply mode in
response to a power mains providing power to the computing device.

7. The computing device of claim 6, wherein processor is to cause the amount of power to be supplied to the I/O port based on the power supply mode being the AC power supply mode, wherein the amount of power is a full power amount.

8. A non-transitory machine-readable storage medium including instructions that when executed cause a processor of a computing device to:
determine a charge amount of a charge storage device of the computing device and an operating mode of the computing device, wherein the charge storage device is to provide power to the computing device;
determine an amount of power to be supplied to an input/output (I/O) port based on the charge amount and the operating mode being a charge storage device saver mode; and
cause the amount of power to be supplied to the I/O port.

9. The non-transitory storage medium of claim 8, including instructions to cause the processor to:
determine the charge amount to be in a first charge amount range; and
cause, in response to the charge amount being in the first charge amount range, a first amount of power to be supplied to the I/O port.

10. The non-transitory storage medium of claim 9, including instructions to cause the processor to:
determine the charge amount to be in a second charge amount range; and
cause, in response to the charge amount being in a second charge amount range, a second amount of power to be supplied to the I/O port, wherein the second amount of power is less than the first amount of power.

11. The non-transitory storage medium of claim 8, including instructions to cause the processor to:
determine the charge amount to be a in a third charge amount range; and
cause; in response to the charge amount being in the third charge amount range; power to the I/O port to be disabled.

12. A computing device; comprising:
a charge storage device;
a universal serial bus type-C (USB-C) port; and
a processor, wherein the processor is to:
cause a first amount of power to be supplied to the USB-C port;
determine a power supply mode of the computing device;
determine a charge amount of the charge storage device and an operating mode of the computing device in response to the power supply mode being a direct current (DC) power supply mode;
determine when the charge amount of the charge storage device is below a threshold amount in response to the operating mode being a charge storage device saver mode; and
alter an amount of power to be supplied to the USB-C port from the first amount of power to a second amount of power in response to the charge amount being below the threshold amount.

13. The computing device of claim 12, wherein the processor is to:
determine the computing device is connected to a power mains; and
modify the power supply mode from the DC power supply mode to an alternating current (AC) power supply mode in response to the computing device being connected to the power mains.

14. The computing device of claim 13, wherein the processor is to:
modify the operating mode from a charge storage device mode to a performance mode in response to the power supply mode being the AC power supply mode;
determine a third amount of power to be supplied to the USB-C port based on the operating mode being the performance mode; and
cause the third amount of power to be supplied to the USB-C port.

15. The computing device of claim 12, wherein the processor is to:
modify the operating mode from the charge storage device saver mode to a performance mode in response to a user input;
determine a third amount of power to be supplied to the USB-C port based on the operating mode being the performance mode; and
cause the third amount of power to be supplied to the USB-C port.
